(19) United States
(12) Patent Application Publication
(10) Pub. No.: US 2004/0093095 A1
(43) Pub. Date: May 13, 2004

(54) Electronic device

(75) Inventors: Akihiro Kojou, Hamura-shi (JP); Koichi Dewa, Ome-shi (JP); Toshikazu Morisawa, Tokorozawa-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/637,621

(22) Filed: Aug. 11, 2003

(30) Foreign Application Priority Data
Nov. 12, 2002 (JP) 2002-328409

(51) Int. Cl. G05B 11/01; C09K 11/00

(52) U.S. Cl. 700/13; 700/12; 264/21

(57) ABSTRACT

This invention relates to an electronic device including a lock switch which defines activation permission of the power supply of the electronic device, and a unit which receives an activation instruction from software and invalidates the received activation instruction when the lock switch permits activation.

### CROSS-REFERENCE TO RELATED APPLICATIONS

This application is based upon and claims the benefit of priority from the prior Japanese Patent Application No. 2002-328409, filed Nov. 12, 2002, the entire contents of which are incorporated herein by reference.

### BACKGROUND OF THE INVENTION

1. Field of the Invention

The present invention relates to an electronic device and, more particularly, to an electronic device capable of preventing, by software, activation of the electronic device from software.

2. Description of the Related Art

Recently, the use of electronic devices which generate electromagnetic waves that influence other electronic devices tends to be inhibited in taking off/landing an airplane or in a hospital or the like. Even a portable personal computer must be powered off in taking off/landing an airplane.

Even if the user powers off an electronic device at this request, the electronic device may be erroneously powered on (e.g., the panel may be erroneously opened to power on the electronic device by a panel switch). Also, the electronic device may be powered on by a function installed for convenience (e.g., the electronic device is powered on by an ON signal from a modem or timer). The user may be held responsible in such case.

To solve this problem, a technique of attaching a power supply lock switch to an electronic device and even if the panel switch is erroneously turned on or a power ON signal is output from a modem or timer, invalidating the switch or signal by hardware is disclosed (Jpn. Pat. Appln. KOKAI Publication No. 2002-99359 (p. 4, FIG. 1).

According to the conventional technique, the power supply switch, the panel switch, or an ON signal from the modem or timer is invalidated by hardware. However, the electronic device is activated (including wakeup: this also applies to the following description) by another factor.

For example, the electronic device has a function of temporarily activating it and performing hibernation (resume) when the battery becomes low. In this case, a conventional electronic device cannot prevent activation.

Such activation function can be permitted/inhibited via a user interface in an OS (Operating System). In the OFF or suspend state, activation setting cannot be done. The user must temporarily activate the electronic device and inhibit the setting via the user interface in the OS.

### BRIEF SUMMARY OF THE INVENTION

According to the embodiment of the present invention, there is provided an electronic device comprising: means for inhibiting activation of the electronic device; means for holding information representing whether activation is inhibited by the inhibiting means; and means for executing activation or activation inhibition of the electronic device on the basis of the information stored in the storage means when an activation instruction is generated in the electronic device.

According to the embodiment of the present invention, there is provided an electronic device comprising: means for inhibiting activation of the electronic device; and means for, when an activation instruction is generated from software which runs in the electronic device, deciding whether activation of the electronic device is inhibited by the inhibiting means, and when activation is inhibited, inhibiting activation of the electronic device.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the internal system of a personal computer having a lock switch according to an embodiment of the present invention; and

FIG. 2 is a flow chart for explaining EC operation of the PC according to the embodiment of the present invention.

### DETAILED DESCRIPTION OF THE INVENTION

A notebook type personal computer according to a preferred embodiment of the present invention will be described below with reference to the several views of the accompanying drawing.

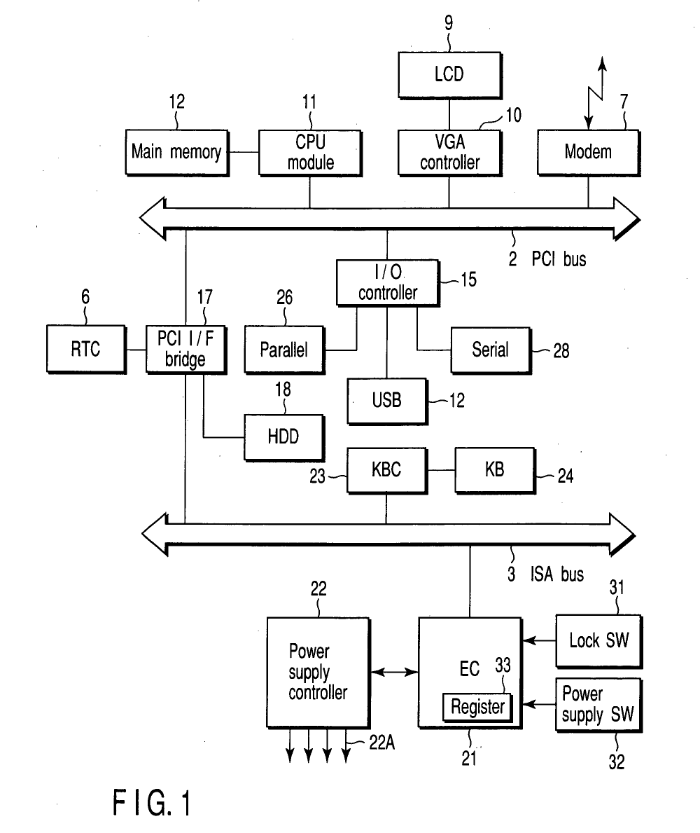

FIG. 1 shows the internal system of a personal computer having a lock switch according to the embodiment of the present invention. The computer system shown in FIG. 1 is a battery-drivable notebook type personal computer (to be referred to as a PC hereinafter). The personal computer comprises a power supply controller (PSC) 22 which controls power supplied from a battery (not shown). The power supply controller (PSC) 22 supplies various power supply voltages from a voltage output terminal 22A to respective parts of the system.

In addition to the power supply controller (PSC) 22, as shown in FIG. 1, the PC system comprises a PCI bus 2, ISA bus 3, CPU module 11, main memory 12, VGA controller 10, I/O controller 15, PCI interface bridge (PCI I/F) 17, HDD 18, embedded controller (EC) 21, keyboard controller (KBC) 23, and keyboard (KB) 24.

The CPU module 11 executes operation control of the whole system and data processing. The CPU module 11 incorporates a CPU, a cache, and a memory controller for controlling the main memory 12.

The main memory 12 is used as the main storage of the system. The main memory 12 stores an operating system, an application program to be processed, and user data created by the application program.

The VGA controller 10 controls an LCD 9 used as the display monitor of the system, and an external CRT.

The I/O controller 15 is a gate array for controlling various I/O devices in the PC. The I/O controller 15 controls devices connected to various I/O connectors such as a serial port 26, parallel port 27, and USB port 28 which are formed on the back surface of the PC main body.

The PCI interface bridge (PCI I/F) 17 is a gate array implemented by a 1-chip LSI. The PCI I/F 17 incorporates a bridge function which connects the PCI bus 2 and ISA bus 3 in two ways. The PCI I/F 17 further incorporates an IDE controller for controlling the HDD 18. The PCI I/F 17 is connected to a real time clock (RTC) 6.

The real time clock (RTC) 6 has a function of shifting the PC main body in the sleep or OFF state to the ON state at a predetermined time designated by the user. The PCI I/F bridge 17 detects the predetermined time, and supplies an activation (including wakeup: this also applies to the following description) request to the embedded controller (EC) 21.

The PCI I/F bridge 17 detects whether a modem 7 has received a ringing signal upon termination, and if so, outputs an activation request to the EC 21.

In response to this activation request, the embedded controller (EC) 21 supplies a power supply request to the power supply controller 22, shifting the PC main body to the ON state.

The embedded controller (EC) 21 manages the power supply state of the PC main body in cooperation with the power supply controller (PSC) 22. The embedded controller (EC) 21 and power supply controller (PSC) 22 keep receiving operating power even if the PC main body is powered off and shifts to the sleep state or OFF state. The embedded controller (EC) 21 has a function of controlling the power supply controller (PSC) 22 in response to detection of generation of an activation factor, and notifying a system BIOS of the generated activation factor as a power management event.

The power supply controller (PSC) 22 is connected to a lock switch 31 and power supply switch 32. In normal operation, when the power supply switch 32 is pressed, the power supply controller (PSC) 22 supplies an operating voltage to each part of the PC main body. The PC main body in the sleep or OFF state shifts to the ON state.

The system shown in FIG. 1 comprises the lock switch 31 which prevents the PC main body from operating due to an external factor or erroneously in a situation in which the operation of the PC main body is unpreferable.

In an unlocked state in which the lock switch 31 is not turned on, if either the power supply switch 32 or lock switch 31 is pressed, the power supply controller (PSC) 22 is instructed to supply power. The power supply controller (PSC) 22 supplies power to each part of the PC, shifting the PC main body in the sleep or OFF state to the ON state. Similarly, if the PCI I/F bridge 17 detects a device activation factor for the real time clock (RTC) 6, modem 7, or the like, the PCI I/F bridge 17 outputs an activation request to the EC 21. The EC 21 outputs a power supply request to the power supply controller (PSC) 22. The power supply controller (PSC) 22 supplies power to each part of the PC, shifting the PC main body in the sleep or OFF state to the ON state.

To the contrary, when the lock switch 31 is turned on to set a locked state, no power supply request is supplied to the power supply controller 22 even if either the lock switch 31 or power supply switch 32 is pressed. The PC main body maintains the sleep or OFF state. Even if a device activation factor for the real time clock (RTC) 6, modem 7, or the like is detected and the EC 21 receives an activation request from the PCI I/F bridge 17, no power supply request is output to the power supply controller 22, and the PC main body maintains the sleep or OFF state.

Even upon reception of another software factor such as an activation request accompanied by hibernation which is performed in correspondence with a low-battery state, no ON signal is supplied to the power supply controller 22 when the lock switch 31 is in the locked state. The PC main body maintains the sleep or OFF state.

The EC 21 comprises a register 33. The register 33 stores information representing the locked/unlocked state of the lock switch 31. The EC 21 decides the locked/unlocked state of the lock switch 31 on the basis of information stored in the register 33.

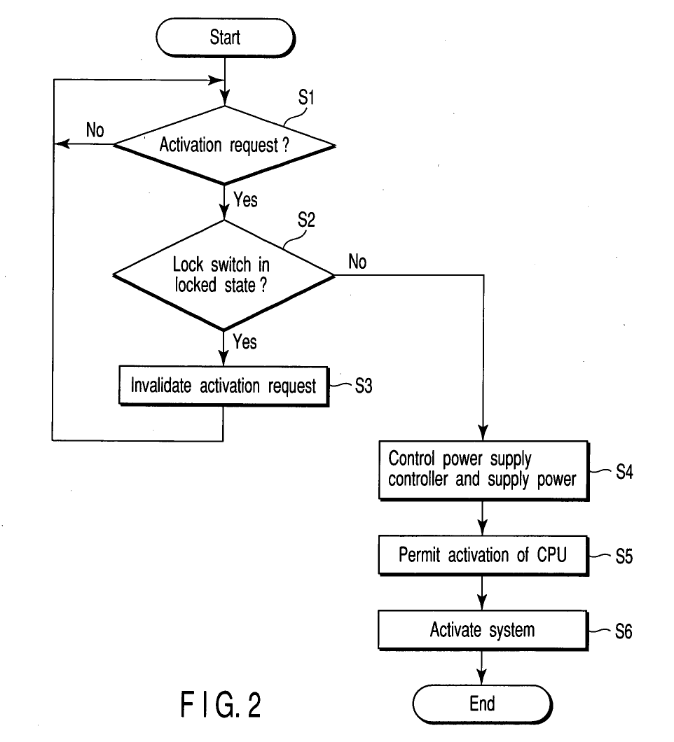

EC operation of the PC according to the embodiment of the present invention will be explained with reference to the flow chart of FIG. 2.

Operation when an activation request is output in the sleep or OFF state of the PC will be described.

The EC 21 decides whether activation requests based on software and hardware factors have been issued (S1). As for activation requests to the EC 21 from the RTC 6 and a device connected to the PCI bus 2, the PCI I/F bridge 17 detects the activation requests from the RTC 6 and the device connected to the PCI bus 2, and requests activation of the EC 21.

If YES in S1, the EC 21 decides whether the lock switch 31 is in the locked state (S2).

If YES in S2, the EC 21 invalidates the received activation request (S3), and returns to processing in S1. That is, the EC 21 invalidates all activation requests based on hardware and software factors on the basis of the state of the lock switch. System activation can, therefore, be completely prevented.

If NO in S2, the EC 21 permits the power supply controller 22 to supply power, and power is supplied to each part of the PC (S4).

The EC 21 permits the PCI I/F bridge 17 to activate the CPU (S5), and then the system is activated (S6).

In the PC according to the embodiment of the present invention, the EC 21 decides the state of the lock switch and invalidates an activation request. Activation based on all hardware and software factors can be prevented.

The present invention is not limited to the above embodiment, and can be variously modified without departing from the spirit and scope of the invention in practical use.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device comprising:
means for inhibiting activation of the electronic device;
means for holding information representing whether activation is inhibited by the inhibiting means; and
means for executing activation or activation inhibition of the electronic device on the basis of the information stored in the storage means when an activation instruction is generated in the electronic device.

2. A device according to claim 1, wherein the inhibiting means is arranged in a housing of the electronic device.

3. A device according to claim 1, wherein the control means includes a sub-processor different from a main processor arranged in the electronic device.

4. A device according to claim 1, wherein the control means includes a sub-processor different from a main processor arranged in the electronic device, and the storage means is arranged in the sub-processor.

5. A device according to claim 2, wherein the inhibiting means designates inhibition even when the electronic device is OFF.

6. A device according to claim 3, which further comprises a power supply controller that manages a power supply of the electronic device, and in which the control means issues a power supply request to the power supply controller when the activation instruction is received and activation of the electronic device is permitted.

7. An electronic device comprising:
means for inhibiting activation of the electronic device; and
means for, when an activation instruction is generated from software which runs in the electronic device, deciding whether activation of the electronic device is inhibited by the inhibiting means, and when activation is inhibited, inhibiting activation of the electronic device.

8. A device according to claim 7, wherein the inhibiting means is arranged in a housing of the electronic device.

9. A device according to claim 7, wherein the control means includes a sub-processor different from a main processor arranged in the electronic device.

10. A device according to claim 8, wherein the inhibiting means designates inhibition even when the electronic device is OFF.

11. A device according to claim 7, which further comprises a power supply controller that manages a power supply of the electronic device, and in which the control means issues a power supply request to the power supply controller when the activation instruction is received and activation of the electronic device is permitted.

12. An electronic device comprising:
means for inhibiting activation of the electronic device;
means for holding information representing whether activation is inhibited by the inhibiting means; and
means for executing activation or activation inhibition of the electronic device on the basis of the information stored in the storage means upon reception of one of an activation instruction from a power supply switch arranged in a housing of the electronic device, an activation instruction from software which runs in the electronic device, and an activation instruction from a network connected to the electronic device.

13. A power supply control method in an electronic device, comprising:
storing information representing activation inhibition or activation permission of the electronic device that is designated by inhibiting means for inhibiting activation of the electronic device;
receiving an activation instruction for the electronic device from software which runs in the electronic device; and
inhibiting activation of the electronic device when the stored information represents activation inhibition.

14. A method according to claim 13, wherein storage of the information, reception of the activation instruction, and activation inhibition of the electronic device are performed by a sub-processor.

15. A method according to claim 13, wherein
a power supply controller which manages a power supply of the electronic device is further arranged, and
a power supply request is issued to the power supply controller when the activation instruction for the electronic device is received and the information permits activation.

16. A power supply control method in an electronic device having inhibiting means for inhibiting activation of the electronic device, and storage means for holding information representing whether activation is inhibited by the inhibiting means, comprising:
receiving an activation instruction from a power supply switch arranged in a housing of the electronic device, an activation instruction from software which runs in the electronic device, or an activation instruction from a network connected to the electronic device; and
executing activation or activation inhibition of the electronic device on the basis of the information stored in the storage means.
